(19) United States
(12) Patent Application Publication
(10) Pub. No.: US 2025/0160242 A1
(43) Pub. Date: May 22, 2025

(54) CLOSING WHEEL WITH RIM

(71) Applicant: SCHAFFERT MANUFACTURING COMPANY, INC., Indianola, NE (US)

(72) Inventor: Paul E. SCHAFFERT, Indianola, NE (US)

(21) Appl. No.: 18/954,264

(22) Filed: Nov. 20, 2024

Related U.S. Application Data
(60) Provisional application No. 63/601,514, filed on Nov. 21, 2023.

(51) Int. Cl. A01C 5/06

(52) U.S. Cl. CPC A01C 5/068

(57) ABSTRACT

A closing wheel includes a hub including an outer circumferential hub surface extending a width between a first hub edge and a second hub edge, the first hub edge defining an outer hub diameter. The hub also includes a channel defined by and recessed into the outer circumferential hub surface. The closing wheel also includes a rim configured to couple to the hub within the circumferential channel, the rim including a coupling portion configured to extend into the circumferential channel, a contact portion extending outward from the coupling portion between a first contact edge and a second contact edge. The contact portion defines an outer circumferential wheel surface extending at least the width and between the first contact edge and the second contact edge and an outer rim diameter greater than the outer hub diameter.

### CROSS-REFERENCE TO RELATED APPLICATIONS

This application claims the benefit of priority pursuant to 35 U.S.C. § 119 (e) of U.S. Provisional Patent Application No. 63/601,514, filed Nov. 21, 2023, entitled “CLOSING WHEEL WITH RIM,” which is hereby incorporated by reference herein in its entirety.

### FIELD

This invention relates generally to closing wheels for seed furrow closing assemblies, methods of use, and methods of manufacturing thereof, and more specifically to modular closing wheel assemblies.

### BACKGROUND OF THE INVENTION

Agricultural seed planting is typically accomplished by multi-row planters. A planter may include multiple row units configured for opening a seed furrow, depositing seeds within the furrow, and closing the seed furrow around and over the seeds. Conventional closing wheels may be coupled to the row units for closing seed furrows and distributing the soil over and into the seeded furrows after the seed has been placed in the furrow.

The use of closing wheels and press wheels on planters to close furrows and compact soil around and over seeds deposited in the bottom of a seed furrow has been practiced for many years. The purpose of compacting the soil is to promote seed germination by reducing air pockets, thus improving the capillary action of the moisture in the soil as well as reducing wind erosion of the soil over the seed.

Traditionally, closing wheels may include rubber tires or a rim mounted over a central hub having a fixed diameter that are pulled along a seed furrow to break down sides of a furrow to redistribute the soil over the seed. However, conventional rubber tire closing wheels may smear the soil over the seed furrow area, rather than evenly distributing the soil. As a result, the furrow may not be completely closed or a hard sidewall to the furrow may be formed. Smearing may be particularly an issue when the soil is wet due to precipitation or when liquid fertilizers or other liquids are distributed with a seed into the furrow. Other conventional closing wheels utilize metal features in place of rubberized tires. The metal features used for soil redistribution and furrow closing can take the form of repeating extensions, or tines extending from a periphery of the closing wheel. The metal features can require complicated machining and cutting paths, increasing manufacturing costs. Additionally, when a single metal feature breaks or is damaged on an entirely metal wheel, the whole wheel must be replaced. As a result, manufacturing and repairing closing wheels with metal tines may be costly and produce large amounts of waste compared to the amount of material used for the completed closing wheel. Other conventional closing wheels attempt to combine the two, with a metal rim placed on a hub. Because the fields include terrain of varying height or because a farmer may need a furrow depth greater than a tine length, both the rim and the hub often contact the soil during use. The contact with the soil results in wear on both the rim and the hub, and in some instances requires both the rim and the hub to be replaced. Additionally, conventional hubs are often not designed for sustained contact with the soil and may wear down prematurely. Premature wear may result in poor performance of the closing wheel, such as because the hub and the rim are not adequately engaged together, allowing the closing wheel to sometimes slip relative to the hub. In this example, the hub may need to be replaced, and in some examples the hub and the rim may need to be replaced. As a result, conventional closing wheels, as well as conventional hubs and rims, may not provide cost effective and durable closing wheels. Accordingly, there is a need for replaceable, cost effective, and durable closing wheel assemblies.

### BRIEF SUMMARY OF THE INVENTION

Examples of the present invention are directed to closing wheel assemblies, components, and methods of use thereof.

In one example, a closing wheel may include a hub including an outer circumferential hub surface extending a width between a first hub edge and a second hub edge, the first hub edge defining an outer hub diameter. The hub may also include a channel defined by and recessed into the outer circumferential hub surface. The closing wheel may also include a rim configured to couple to the hub within the circumferential channel, the rim including a coupling portion configured to extend into the circumferential channel, a contact portion extending outward from the coupling portion between a first contact edge and a second contact edge. The contact portion may define an outer circumferential wheel surface extending at least the width and between the first contact edge and the second contact edge and an outer rim diameter greater than the outer hub diameter.

In another example of the closing wheel, the rim may define a central longitudinal axis and the rim defines a t-shaped cross sectional area perpendicular to the longitudinal axis.

In another example of the closing wheel, the rim may further include a retaining feature configured to interface with the hub to resist a movement of the rim relative to the hub.

In another example of the closing wheel, the contact portion may define an inner surface configured to contact the outer circumferential hub surface

In another example of the closing wheel, the retaining feature may extend from the inner surface and engage the outer circumferential hub surface.

In another example of the closing wheel, a hub retaining feature may be configured to engage or receive the retaining feature.

In another example of the closing wheel, the width may be a first width, the channel may include a second width smaller than the first width, and the coupling portion may include a third width substantially the same as the second width.

In one example of a closing wheel, the closing wheel may couple to a trailing arm assembly of a planter. The closing wheel may include a hub including an outer hub edge and a width and a rim configured to couple to the hub. The rim may include an outer circumferential rim surface extending at least the width and between a first contact edge and a second contact edge and repeating teeth extending radially outward from the outer circumferential rim surface.

In another example of the closing wheel, the outer hub edge may define an outer hub diameter less than an outer rim diameter defined by the outer circumferential rim surface.

In another example of the closing wheel, the outer circumferential hub surface may define a channel.

In another example of the closing wheel, the rim may include a coupling portion configured to extend into the channel.

In another example of the closing wheel, the coupling portion may include a coupling width less than the width.

In another example of the closing wheel, the channel may include a channel width substantially the same as the coupling width.

In another example of the closing wheel, the repeating teeth may be configured to disturb soil to close a seed furrow.

In one example of a rim for an agricultural closing wheel, the rim may include a coupling portion having a first width, a contact portion extending outward from the coupling portion between a first contact edge and a second contact edge, the contact portion defining an outer circumferential surface extending a second width between the first contact edge and the second contact edge, the second width greater than the first width, and repeating teeth extending radially outward from the outer circumferential surface.

In another example of the rim, the coupling portion and the contact portion may define a T-shaped cross-sectional area of the rim.

In another example of the rim, the contact portion may be disposed between the coupling portion and the repeating teeth.

In another example of the rim, the contact portion may extend perpendicular to the coupling portion.

In another example of the rim, the repeating teeth may be configured to disturb soil to close a seed furrow when the rim is coupled to an agricultural trailing arm assembly.

In another example of the rim, the rim further may include a retaining feature extending from the contact portion opposite the repeating teeth.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a side view of an agricultural tractor and an agricultural planter;

FIG. 2 depicts a top-rear perspective view of the agricultural tractor and agricultural planter of FIG. 1, with a closing wheel;

FIG. 3 depicts a top-rear perspective view of a tail section of the agricultural planter and the closing wheel of FIG. 2;

FIG. 4 depicts a perspective view of an example closing wheel;

FIG. 5 depicts an exploded view of the closing wheel of FIG. 4;

FIG. 6 depicts a perspective view of an example rim for a closing wheel;

FIG. 7A depicts a left elevation view of an example closing wheel;

FIG. 7B depicts a rear elevation view of the closing wheel of FIG. 7A;

FIG. 7C depicts a cross sectional view of the closing wheel of FIG. 7A;

FIG. 7D depicts a cross sectional view of the closing wheel of FIG. 7A;

FIG. 8A depicts a rear elevation view of a pair of example closing wheels and a seed in an open seed furrow;

FIG. 8B depicts a rear elevation view of the closing wheels of FIG. 8A and a seed in a closed seed furrow; and

FIG. 9 depicts a close up perspective view of an example rim.

### DETAILED DESCRIPTION OF THE INVENTION

The description that follows includes sample systems, methods, and apparatuses that embody various elements of the present disclosure. However, it should be understood that the described disclosure may be practiced in a variety of forms in addition to those described herein.

The following disclosure relates generally to modular closing wheels and associated systems and methods of use thereof. Closing wheels are generally a part of a trailing arm assembly coupled to an agricultural planter used to plant seeds. Broadly, a closing wheel may be substantially any type of wheel or soil distributing device for closing seeded furrows by distributing soil into and over the planted furrow. For example, a closing wheel may be configured to distribute soil into and over the furrow in order to promote seed germination by covering the seeds, compacting soil and reducing air pockets. This can improve the capillary action of the moisture in the soil as well as reducing wind erosion of the soil over the seed. Closing wheels can also be configured modularly (e.g. made of two or more separately replaceable components) to facilitate less material waste during manufacturing, more compact and less expensive shipping, and cheaper, simpler repairs.

To facilitate the foregoing, closing wheels of the present disclosure may include a rim mounted on or coupled to a central hub configured to rotate about a central axis. In one example, the hub may be formed from two or more separate portions. In one example, two portions may be coupled along corresponding faces. The two portions may include faces aligned with a plane generally transverse or perpendicular to an axis of rotation of the hub. The hub may include or define a recessed channel formed at least partially around the periphery of the hub. The recessed channel, in one example, may be positioned on the radial surface of the hub. The recessed channel may be defined by or extend radially downward toward the hub from around the outer circumferential hub surface or exterior perimeter of the hub. The recessed circumferential channel feature may act as a rim supporting feature and receive the rim or a portion of the rim. In one example, the hub may have an outer diameter that is less than or equal to a diameter of the rim.

The rim may include a coupling portion configured to engage with, or be received by, the hub. The rim may include a contact portion extending over an outer circumferential hub surface to protect the hub during use. The rim may include repeating teeth or radial extensions extending outwardly from a perimeter or outer circumferential surface of the rim for engaging the soil during use. The contact portion and the repeating teeth may contact soil during use, facilitating distribution of soil while protecting the hub from wear or damage. The repeating teeth may be angled to extend in any of a variety of directions. For example, the repeating teeth may extend radially, or at an angle to the plane of the hub, or both. The repeating extensions may assist in breaking down compacted seed furrow sidewalls, clumps of soil, and distributing the soil into and over a planted seed in a furrow. The closing wheel itself may be coupled to a trailing arm assembly of an agricultural planter at an angle, which may allow the spikes to direct soil towards a location of a seed in a furrow.

Accordingly, the closing wheels of the present disclosure include rims extending radially and laterally beyond the outer edges of the hub to which the rim is secured. In this way, the rim makes contact, or at least primary contact, with the soil during operation rather than the hub. Thus, the hub can be made of cheaper, lighter weight materials such as plastics, with a reduced risk of wearing down due to constant contact with the soil. Rather, the rim, which can be made of a harder, more durable material such as metal, makes contact with the soil and prevents the hub from wearing down over time.

In some examples, a gasket may be placed between the hub and the rim. The gasket may have a relatively high coefficient of friction, such as for example rubber, that may limit the movement of the rim relative to the hub and prevent slippage of the rim during use.

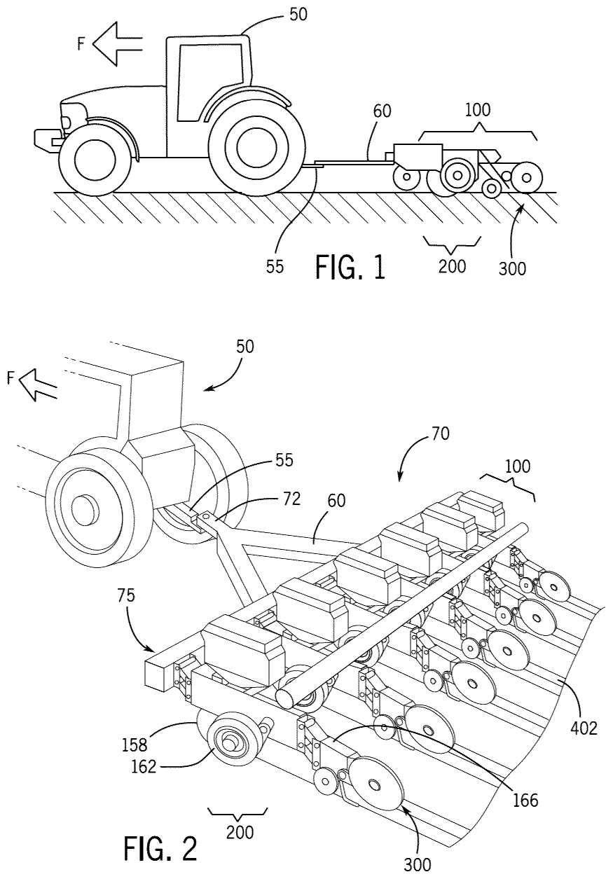

Turning to the Drawings, the closing wheel of the present disclosure may be used with an agriculture planter 70 having one or more trailing arm assemblies 100, as shown in FIG. 1. Each trailing arm assembly 100 may include a fertilizer furrow opener assembly 150. The fertilizer furrow opener assembly 150 may be configured to open the soil, such as with an opener disc, and optionally supply fertilizer and/or a seed 20 to an open furrow 401. Each trailing arm assembly 100 may also include a trailing furrow closer assembly 200. The trailing furrow closer assembly 200 may be configured to close the open seed furrow 401 creating a closed seed furrow 402, such as with the closing wheel 300 of the present invention. As described and shown herein, one or more closing wheels, such as the closing wheels 300 of the present disclosure may be connected to the trailing arm assemblies 100. One or more press wheels may be connected to an end of the trailing arm assemblies 110. This may allow the press wheel to firm the closed seed furrow 402 after closing.

The closing wheels 300 of the present disclosure may be used with a variety of different planters and trailing arm assemblies. For purposes of illustration, FIGS. 1 and 2 show the planter 70 as including a tongue 72 or hitch 55 for hitching the planter 70 to a hitch 55 of a tractor 50. The tractor 50 tows the planter 70 in the direction of arrow F and provides power to the planter 70 (e.g., via a power take off (“PTO”)) for powering the operations of the planter 70. As illustrated in FIG. 2, the planter 70 may include a frame 75 from which the hitch 55 extends and the various planter components are supported. The various components of the planter 70 may include the plurality of trailing arm assemblies 100. The trailing arm assemblies 100 may function as row units for planting seeds and distributing liquid fertilizer, for example, from a common liquid fertilizer tube 170.

While many configurations are possible, each row unit shown in FIG. 2 may include a frame 154 for supporting various components of the planter 70. The row units in FIG. 2 are shown as including a furrow opener disc 158, a gage wheel 162, and a furrow closer frame 166. Broadly, the seed furrow opener disc 158 may be configured to create a furrow in which the planter 70 deposits seed. In creating the seed furrow, the furrow opener disc may form a seed furrow sidewall, which may include harder or more compacted soil. The gage wheel 162 may be configured to determine or control a depth at which the planter 70 deposits the seed. However, the terrain may vary between the location of the closing wheel 300 and the gage wheel 162, resulting in the closing wheel 300 contacting the soil at varying depths. The planter 70 may further include a series of the trailing arm assemblies 200, each of which may include a closing wheel 300 followed by a press wheel and associated subassemblies. This configuration allows for treating the soil after the furrow has been closed by the closing wheel 300.

Any of the features, components, and/or parts, including the arrangements and configurations thereof shown in FIGS. 1 and 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1 and 2.

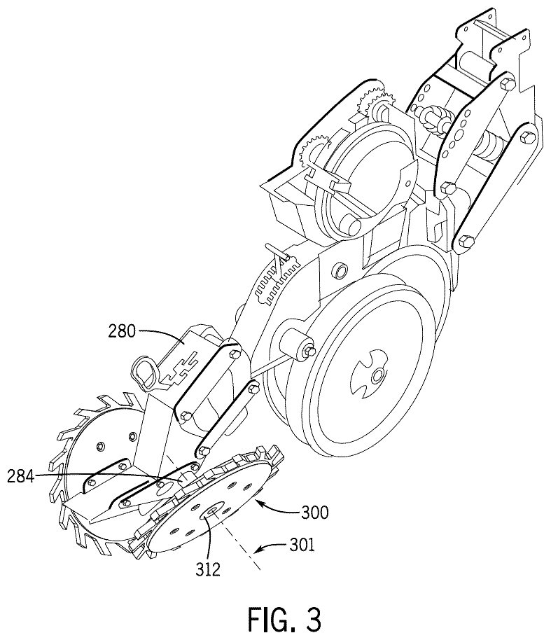

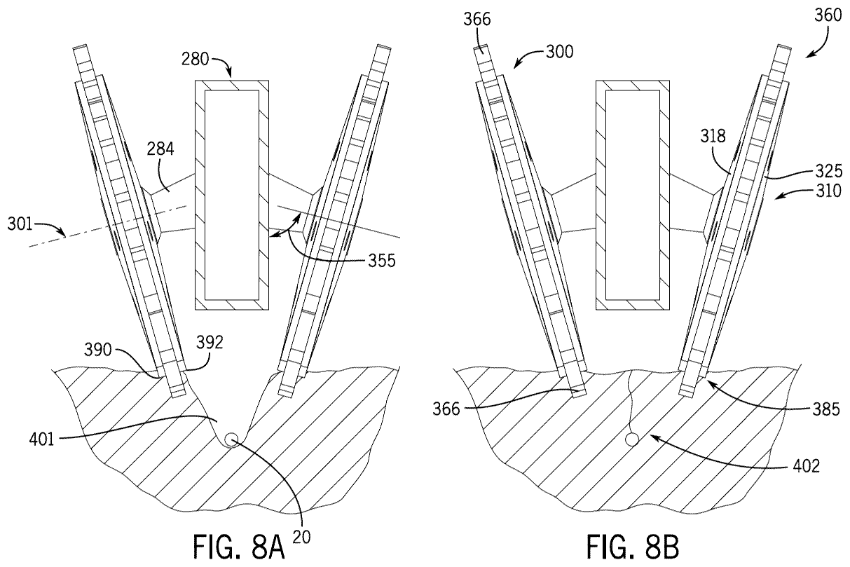

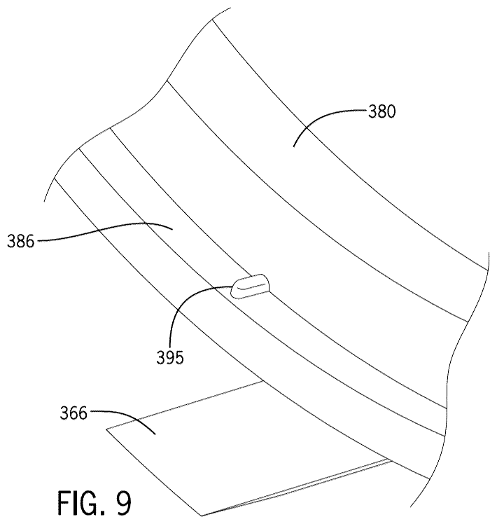

As shown in FIG. 3 and with reference to FIGS. 8A and 8B, the one or more closing wheels 300 may couple to either side of a mounting fork 280. For example, the closing wheel 300 may include a bearing 312 attached to or engaged with a feature of the mounting fork 280, such as an axle 284 or another feature allowing rotation of the closing wheel 300 relative to the fork 280. The closing wheel 300 may be configured to rotate about an axis of rotation or central axis 301. The axis of rotation may be defined by the axle 284, bearing 312, or other features rotatably coupled or attached to the closing wheel 300. The closing wheel 300 is generally configured to rotate about the central axis 301 when the tractor 50 is in motion. As the closing wheel 300 rotates, it may break up or move soil. For example, the closing wheel 300 may apply a downward pressure, a cutting action, or apply a force sufficient to move, break up, or compact soil of, around, or into an open seed furrow 401 and form a closed seed furrow 402. The force may originate with the trailing arm assembly 100 or may be the result of the positioning of the one or more of the closing wheels 300.

In some examples, only one closing wheel 300 or more than two closing wheels 300 may be used. In some examples, modular closing wheels 300 may be staggered such that one modular closing wheel 300 is located in a direction closer to the tractor while another closing wheel may be located further from the tractor 50. The position of a closing wheel 300 may be independent of the location of the opener disc 158 or other features of the trailing arm assembly 100. For example, in some uses the closing wheel 300 may be placed in front of, or closer, to the opener disc 158. In such an example, the closing wheel 300 may act to disturb dirt but not to so much as to fully close an open seed furrow 401. In further examples, one closing wheel 300 may be behind a separate closing wheel and may act to compact soil on a seed furrow 401 or move additional soil to or from the seed furrow.

Any of the features, components, and/or parts, including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

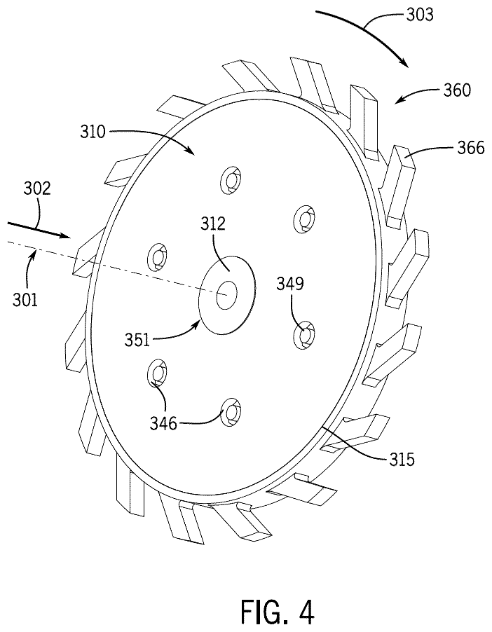

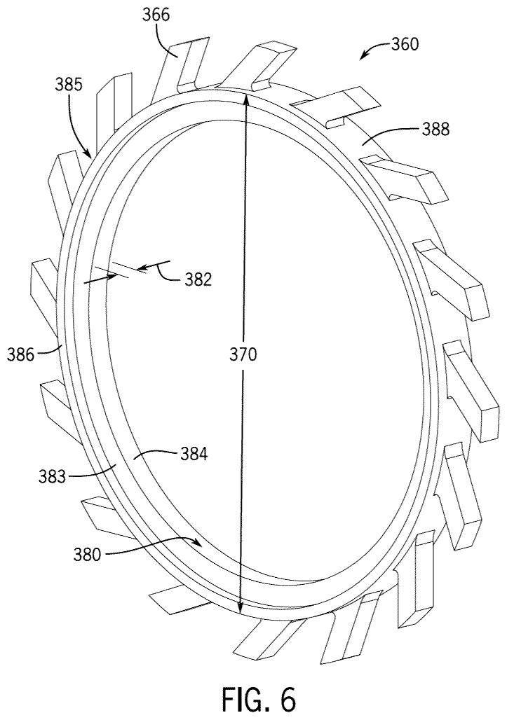

With reference to FIG. 4 through FIG. 7C, an example closing wheel 300 of the present disclosure is shown. The closing wheel 300 may include a hub 310 and a rim 360. The bearing 312 or similar feature may also be included to facilitate rotation of the modular closing wheel 300 relative to the trailing arm assembly 100 or the mounting fork 280. An insert 400 may be included to aid in securing the rim 360 to the hub 310 and limiting rotation of the rim 360 relative to the hub 310 during use.

The hub 310 may be a component uniquely designed for receiving the rim 360. Alternatively, the hub 310 may be a conventional hub configured to utilize a runner tire or conventional closing wheel rims, and the rim 360 of the present disclosure may be configured for attachment to or placement on the conventional hub. In examples where the hub 310 may be a conventional hub, the cost to a user may be reduced by requiring the purchase of only the rim 360 of the present disclosure rather than an entire closing wheel assembly.

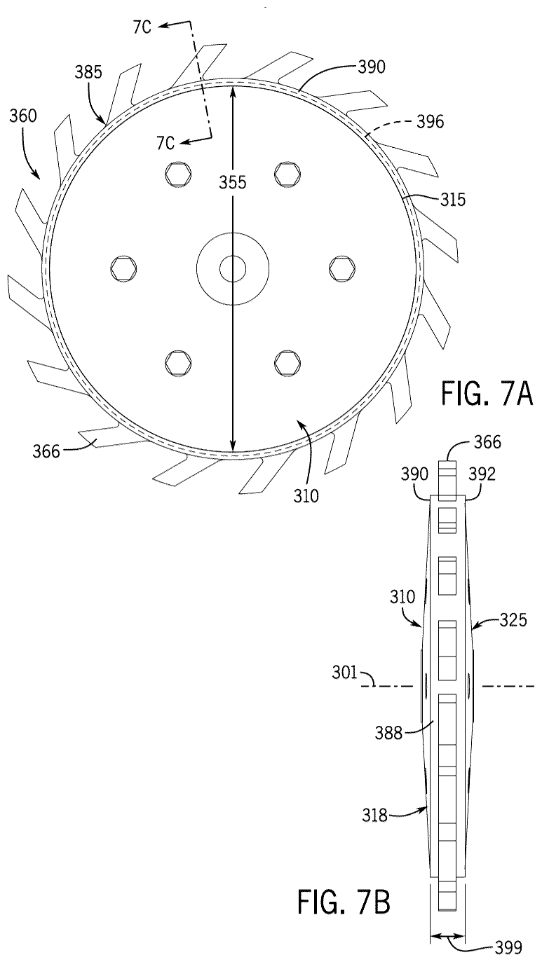

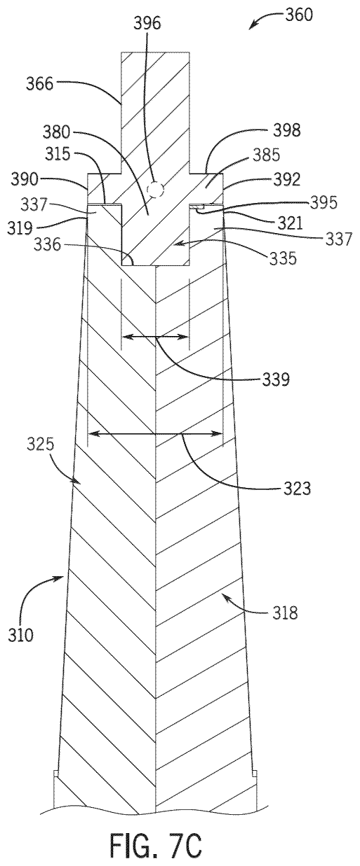

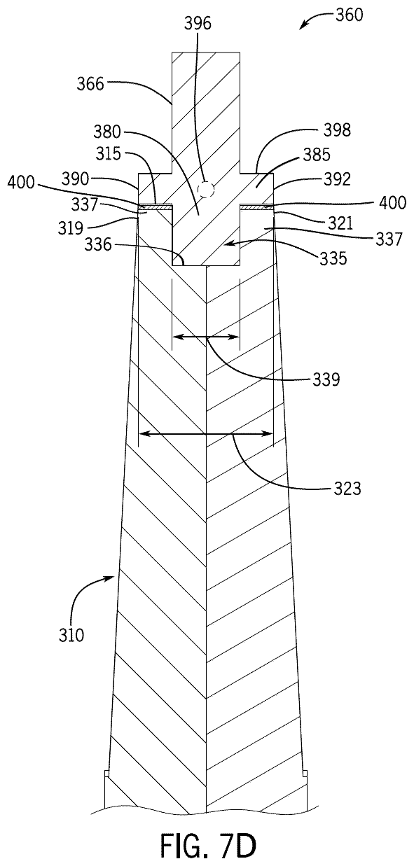

The hub 310 may be a central portion of the modular closing wheel 300. The hub 310 may have a circular shape or perimeter when viewed from a direction parallel to the central axis of rotation 301, which may define the axial direction 302, as indicated in FIG. 4 and as may be shown in FIG. 7A. When viewed from a direction perpendicular to the axial direction 302, as may be shown in FIG. 7B and FIG. 7C, the hub 310 may be elliptical, rectangular, trapezoidal, round, or various other shapes.

The hub 310 may be a single object or component. Alternatively, the hub 310 may be formed from a plurality of separate portions, which in one example may be two portions. When the hub 310 is formed from two or more portions, there may be a first portion 318 and a second portion 325. The first portion 318 and the second portion 325 of the hub 310 may each define an exterior face 343 oriented outwards towards the axial direction 302. Each of the portions 318, 325 may define interior faces 328 opposite the exterior faces 343. The interior faces 328 of the first portion 318 and the second portion 325 may be configured to contact, engage, or couple to each other.

The hub 310 may define an outer circumferential hub surface 315. The outer circumferential hub surface 315 may be the perimeter surface or exterior edge surface of the hub 310. The outer circumferential hub surface 315 may extend in the axial direction from the exterior face 343 of the first portion 318 to the exterior face 343 of the second portion 325. The outer circumferential hub surface 315 may be flat or parallel relative in the axial direction 302. In other examples, the outer circumferential hub surface 315 may vary in height or shape along the rotational direction 303 relative to the axis of rotation 301. The first portion 318 or the second portion 325 may each define a portion of the outer circumferential hub surface 315. The outer circumferential hub surface 315 may have a first width dimension or a perimeter width 323. The first width 323 may be defined by the width dimension from a first hub edge 319 to a second hub edge 321, as may be shown in FIG. 7C. The first hub edge 319 may be defined as, or at, an intersection between the exterior face 343 of the first portion 318 and the outer circumferential surface 315. The second hub edge 321 may be defined as, or at, an intersection between the outer circumferential surface 315 and the exterior face 343 of the second portion 325.

The hub 310 may have or define an outer hub diameter 355. The outer hub diameter 355 may be defined as the distance or dimension from one point on the outer circumferential hub surface 315 to another point on the outer circumferential surface 315 opposite the axis of rotation 301. For example, the outer hub diameter 355 may be the distance from a point on the first hub edge 319 through the axis of rotation 301 to another point on the first hub edge 319.

The hub 310 may include rim support features or a recessed circumferential channel 335 defined by or in the circumferential hub surface 315. The recessed circumferential channel 335 may be a channel extending towards the axis of rotation 301 relative to the circumferential hub surface 315. The recessed circumferential channel 335 may be defined by corresponding upright walls 337 extending towards the axis of rotation 301 from the circumferential hub surface 315 to a bottom wall 336. Each of the first portion 318 and the second portion 325 of the hub 310 may define one or both of the corresponding upright walls 337. Each of the first portion 318 and the second portion 325 of the hub 310 may define a single bottom wall 336 or corresponding bottom walls 336. For example, the interior faces 328 of the two portions may define corresponding, or opposing, upright walls 337. The bottom wall 336 or corresponding bottom walls 336 may extend from the interior faces 328 in the axial direction 302. The upright walls 337 may be parallel, offset at an angle relative to each other, or curved. Similarly, the bottom wall or walls 336 may have a curved, angled, or generally flat shape. The recessed circumferential channel 335 may have or define a second width or channel width dimension 339. The channel width dimension 339, as may be shown in FIG. 7C, may be defined as the distance from one of the corresponding upright walls 337 to the other of the corresponding upright walls 337. In some examples, the hub 310 may define two or more recessed channels 335 spaced in the axial direction 302.

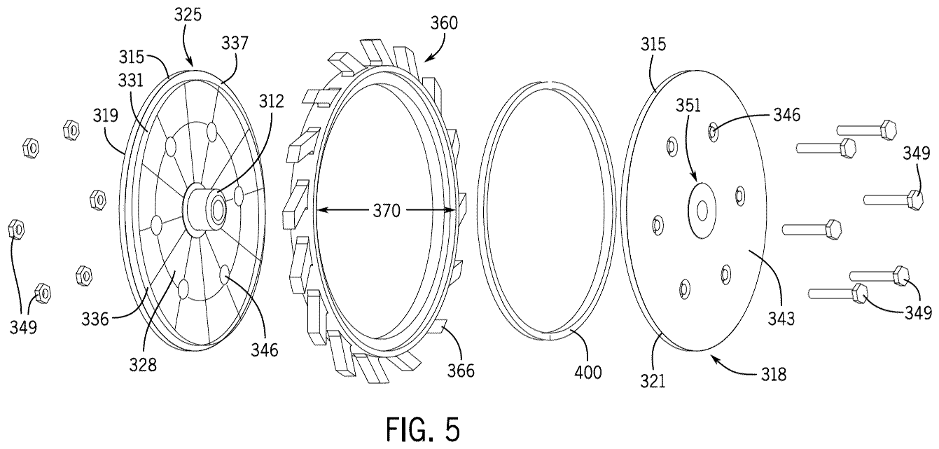

Portions of the hub 310, such as the first portion 318 and second portion 325, may define corresponding hub 310 coupling apertures 346. The hub coupling apertures 346 may extend through the hub 310. The hub coupling apertures 346 may be smooth, threaded, or countersunk to receive a feature of a fastener 349. Hub coupling apertures 346 on the first portion 318 may align with the hub coupling apertures 346 of the second portion 325. The hub coupling apertures 346 may be arranged in a variety of patterns. In one example, the hub coupling apertures 346 may be aligned annularly around a central aperture 351 of the hub 310. Fasteners 349 may be received through the hub coupling apertures 346 and may secure the first portion 318 and second portion 325 of the hub 310 together. The fasteners 349 may include a plurality of bolts and nuts, as shown in FIG. 5, pins, screws, or similar structures.

The hub 310 may also define a central aperture 351 defining an aperture about the axis 301 of rotation and extending through the hub 310 or either the first portion 318 or the second portion 325. The central aperture 351 may be configured to receive a feature of the trailing arm assembly 100 or to receive a bearing 312. The central aperture 351 may be configured to retain or to receive such a feature in the hub 310.

The hub 310 may be made from a variety of materials such as plastics, metals, or other materials sufficient for use in soil. The various components of the hub 310 may be made from the same material or multiple types of materials. For example, either portion 318, 325 of the hub 310 may be integrally formed as a single material (e.g. cast or cut metal, injection molded plastics). In other examples, the hub 310 may include plastic components and metal components.

Any of the features, components, and/or parts, of the hub 310 including the arrangements and configurations thereof shown in FIGS. 4-7C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4-7C.

With continued reference to FIG. 4 through FIG. 7C, an example of the rim 360 is shown. The rim 360 may include a coupling portion 380 configured for engagement with or coupling to the hub 310. The rim 360 may include a contact portion 385 configured to contact or engage with soil during use. The rim 360 may be made from a metal or similar durable and hard material sufficient for repeated use contact with dirt and rock and to break apart hardened soil. The rim 360 may be a single integrally formed component or two or more components joined together to define the rim 360.

The contact portion 385 may be the exterior perimeter or outer circumferential portion of the rim 360. The contact portion 385 may define the outer circumferential wheel surface 388. The outer circumferential wheel surface 388 may extend in the axial direction from a first contact edge 390 to a second contact edge 392. The distance or dimension from the first contact edge 390 to the second contact edge 392 may define a contact rim width 399. The contact portion 385 may further define an inner surface 386. The inner surface 386 may be defined by a section or side of the contact portion 385 opposite or towards the axis of rotation 301 from the outer circumferential wheel surface 388.

The contact portion 385 may define an outer rim diameter or wheel diameter 370 of the rim 360. The coupling portion 385 may be configured to extend into the circumferential channel 335. The outer rim diameter 370 may be defined as the distance or dimension from one point on the outer circumferential rim or wheel surface 388 to another point on the outer circumferential rim or wheel surface 388 opposite the axis of rotation 301. The contact portion may define an inner rim diameter 377. The inner rim diameter 377 may be defined as the distance or dimension from one point on the inner surface 386 of the contact portion 385 to another point on the inner surface 388 opposite the axis of rotation 301

The rim 360 may include repeating teeth or radial extensions 366 extending away from the axis of rotation 301 from an outer circumferential wheel surface 365. The repeating teeth or radial features 366 may be tines, spikes, one or more edges or blades, or other features designed to engage and break down soil. The repeating teeth 366 may be aligned in a single row along the circumferential wheel surface 365 or in a variety of patterns or orientations. For example, the repeating teeth 366 may repeat in the axial direction 302 or the rotational direction 303. The repeating teeth 366 may extend from the wheel surface 365 at an angle, in either the axial direction 302 or the direction of rotation 303, to increase engagement or movement of the soil. For example, the repeating teeth 366 may extend at an angle generally away from the rotational direction 303 when viewed from the axial direction 302. For example, the repeating teeth 366 may be configured to throw or move soil as the repeating teeth 366 leave the soil. In other examples, the repeating teeth 366 may be angled to reduce the amount the soil may be disturbed as the repeating teeth 366 exit the soil. In some examples, the repeating teeth 366 may be of a length or angled to extend through both neighboring soil and a seed furrow sidewall or into the seed furrow. The various configurations of the repeating teeth 366 may promote the breakdown of soil, seed furrow sidewalls, the movement of soil generally, or a proper degree of compaction over seeds 20. Soil compaction in the closed seed furrow 402 may reduce air pockets, promote the capillary action of water through soil, protect planted seeds from wind and weather, and generally promote seed 20 germination and plant growth.

The coupling portion 380 may be an extension from the inner surface 386 of the rim 360. For example, the coupling portion 380 may be a feature extending towards the axis of rotation from 301 from the inner surface 386 (e.g. generally opposite the repeating teeth 366). The coupling portion 380 may be continuous or segmented. The coupling portion 380 may include corresponding axial walls 383 extending towards the axis of rotation 301 to a transverse wall 384. The transverse wall 384 may extend from one of the corresponding axial walls 383 to the other of the corresponding axial walls 383. As shown in FIG. 7C, the coupling portion 380 may have or define a third width or coupling width 382. The coupling width 382 may be the distance or dimension between the corresponding axial walls 383 in the axial direction 302. In some examples, the rim 360 may include two or more coupling portions 380. In such examples, the coupling width 382 may be the width or dimension of any one of the coupling portions 380 or the combined width from an outermost axial wall 383 of one coupling portion 380 to the opposite outermost axial wall 383 in the axial direction 302.

As shown in FIGS. 8A and 8C, the rim 360 may be extend along a longitudinal axis 396 axially spaced from the axis of rotation 301 and extending in the rotational direction 302. When viewed from a perspective perpendicular to the longitudinal axis 396 of the rim 360, the coupling portion 380 and the contact portion 385 may define a perpendicular crossing shape, also referred to as a T-shaped cross-sectional area of the rim 360, with the contact portion 385 extending generally perpendicular relative to (e.g., crossing in the manner of a T-shape) the coupling portion 380. For example, the repeating teeth 366 or the coupling portion 380 may align perpendicular to the axis of rotation 301 and the contact portion may extend parallel or in alignment with the axial direction 302. In other examples, the radial features 366 may extend outwardly or inwardly from the rim 360 in the axial direction 302.

Any of the features, components, and/or parts, of the rim 360 including the arrangements and configurations thereof shown in FIGS. 4-7C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4-7C.

With continued reference to FIGS. 4-7C, the rim 360 may couple to the hub 310 to form the closing wheel 300. As may be shown, the rim 360 may be placed between portions 318 and 325 of the hub 310 with the coupling portion 380 in the recessed circumferential channel 335 of the hub 310. The inner surface 386 of the contact portion 385 may engage with or contact the outer circumferential hub surface 315.

With respect to the coupling portion 380, the upright walls 337 may contact or engage with the axial walls 383. The transverse wall 384 may contact or engage with the bottom wall or walls 336. To ensure a proper fit in the channel 335, the coupling width 382 of the coupling portion 380 may be substantially the same as or similar to the channel width 339. A tighter fit may limit slippage or movement of the rim 360 relative to the hub 310 during use. In some examples, the coupling portion 380 and the channel 335 may have corresponding profiles or shapes. For examples, the axial walls 383 and the upright walls 337 may have corresponding shapes or angles or the bottom wall or walls 336 and the transverse wall 384 may have corresponding shapes or angles. The coupling portion 380 and the recessed circumferential channel 335 may be correspondingly continuous or segmented.

With respect to the contact portion 380, the contact portion 380 may extend over or cover the outer circumferential hub surface 315. The inner surface 388 may have a shape or profile corresponding to the shape or profile of the outer circumferential hub surface 315. The inner surface 386 of the rim 360 may be in contact with or otherwise cover the outer circumferential hub surface 315. For example, the inner diameter 377 of the rim 360 may be equal to or greater than the outer hub diameter 355. The distance from the first contact edge 390 to the second contact edge 392 may be greater than or equal to the hub perimeter width or first width 323 (e.g. the contact rim width 399 may be equal to or greater than the hub perimeter width 323). By covering the hub 310, the rim 360 may protect or limit damage and wear to the hub 310 during use.

Fasteners 349 may be used to secure or couple the portions 318, 325 of the hub 310 together or to assist in securing the rim 360 to the hub 310. In some examples, an insert 400 may be included to limit rotation of rim 360 relative to the hub 310. The insert 400 may be configured for placement between the coupling portion 380 and the recessed circumferential channel 335. In some examples, the insert 400 may be placed between the inner surface 386 of the rim 360 and the outer circumferential hub surface 315. The insert 400 may be made from any of a variety of materials exhibiting a relatively high coefficient of friction sufficient to resist movement of the rim 360 relative to the hub 310. The materials may include rubber, polymers, or adhesives. The insert 400 may have a rectangular, round, or belt-like shape. In one example, the insert 400 may be a rubber belt. A rim 360 configured for use with an insert 400 may have a comparably shorter height when compared to a rim 360 configured for use without an insert 400.

As shown in FIG. 7C, the hub 310 defines opposing portions 318, 325, for example opposing plates, attached together to clamp the rim 360 between the portions 318, 325. Each plate portion 318, 325 defines a shoulder, including the sidewalls 337, on an inner surface of the plate portion 318, 325 near the periphery thereof. When mated with the opposing plate portions 318, 325, the rim 360 is clamped within the channel 335 to form the assembled closing wheel.

In one example, the channel 335 defined by the first and second portions 318, 325 of the hub 310 is straight along the circular, longitudinal axis 396. In one or more other examples, the channel 335 can vary in direction and shape along the axis 396 to be wavy, keyed, or otherwise irregularly shaped. In such examples, the coupling portion 380 of the rim 360 can be likewise shaped and sized to match the shape of the channel 335. In this way, in some examples, the coupling portion 380 of the rim 360 may be keyed to fit within the channel 335 such that the coupling portion 380 and the channel 335 are locked together in position during use.

FIG. 7C also shows a retention feature 395 extending from the contact portion 385 and/or the coupling portion 380 of the rim 360. The retention feature 395 is shown and described in more detail with reference to FIG. 9. In FIG. 7C, the retention feature 395 is shown and can be configured to extend toward the hub 310. A mechanical press fit or friction fit between the retention feature 395 and the hub 310, for example the wall 337 of the hub 310, is configured to resist a relative rotation or movement of the rim 360 and the hub 310 to maintain a fixed position of the rim 360 and the hub 310 during use. This resistance can be in addition to the press fit of the coupling portion 380 between the walls 337 of the hub 310 within the channel 335.

FIG. 7D shows another cross-sectional view of the rim 360 and the hub 210. In the example shown in FIG. 7D, the insert 400 is disposed between the contact portion 385. The insert 400 can include high friction materials such as rubber so resist a movement between the rim 360 and the hub 210 during use. In one example, as shown in FIG. 7D, two inserts 400 are disposed on respective sides of the rim 360 between the contact portion 385 and respective walls 337 of the hub 310. In one or more other examples, one or more inserts 400 can be disposed elsewhere, including vertically between either wall 337 and the coupling portion 380 of the rim 360 and/or horizontally between the contact portion 380 and the bottom wall 336 formed by the hub 310 and defining the channel 335. In at least one example, the insert 400 can be disposed between the retention feature 400 shown in FIG. 7C and the wall 337 of the hub 310 such that the retention feature 395 extends toward and/or into the insert 400 to prevent relative movement between the rim 360 and the hub 310.

Any of the features, components, and/or parts, including the arrangements and configurations thereof shown in FIGS. 4-7D can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4-7D.

With reference to FIGS. 8A and 8B, FIG. 8A shows example closing wheels 300 rotatably coupled to an axle 284 of a mounting fork 280 and placed adjacent an open seed furrow 401, while FIG. 8B shows example closing wheels 300 after closing the seed furrow 402.

As shown in FIGS. 8A, and 8B, the one or more closing wheels 300 may couple to either side of a mounting fork 280 at an angle that may be adjusted or predetermined. The predetermined angle may define a closing angle 355. The closing angle 355 may align the closing wheels 300 relative to an open seed furrow 401 in an arraignment to move soil into or around the open furrow 401. For example, the closing wheels 300 may be positioned to place the repeating teeth or radial features 366 of the closing wheel 300 in contact with the soil. For example, the closing wheel 300 may be positioned such that the repeating teeth 366 of the closing wheels 300 may contact the soil at a position relative to the open seed furrow 401 and at a soil depth sufficient to close the open seed furrow 401 and cover the seed 20 with soil. In some cases, the closing wheels 300 may be positioned on the sides of the seed furrow 401 of to distribute soil towards the center of the open seed furrow 401. Positioning the closing wheels 300 along the sides of the seed furrow 401 may break down the sidewalls of the furrow, thus forming a closed seed furrow 402. Additionally or alternatively, one or more of the closing wheels 300 may be positioned in a spaced relationship outside of the open seed furrow 401 to move additional soil into the open seed furrow 401.

Because the closing wheels 300 are positioned at an angle 355 relative to the open seed furrow 401, more of the closing wheel 300 than the intended repeating teeth 366 may contact the soil. For example, as shown in FIG. 8A, the first contact edge 390 located on the side of the rim 360 may contact the soil. At the same time, the second contact edge 392 may not, or only slightly, contact the soil. By utilizing a rim 360 with a contact portion 385 covering the outer circumferential surface 315 of the hub 310, wear and damage to the hub 310 may be reduced. In other examples, the soil may be of such a consistency that the closing wheel 300 may be positioned at a greater depth in the soil or the height of the soil relative to the mounting fork 280 may vary. In such an example, both contact edges 390 and 392 may be in the soil and the contact portion 385 may prevent wear on both sides of the hub 310.

Any of the features, components, and/or parts, including the arrangements and configurations thereof shown in FIGS. 8A and 8B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 8A and 8B.

With respect to FIG. 9, in some examples the rim 360 may include a retention feature 395. The retention feature 395 may extend from the inner surface 386 of the rim 360 towards the axis of rotation 301. In some examples, the retention feature or additional retention features 395 may extend from the coupling portion 380. The retention feature 395 may be received by, interface with, or engage with the hub 310. In at least one example, the extension feature 395 presses against the hub to form a friction fit between the rim 360 and the hub 310. In one example, the extension feature 395 can form a divot or other complimentary feature in the hub 310 when assembled to mechanically lock the rim 360 to the hub 310 together. In at least one example, the hub 310 includes a prefabricated feature complimentary to the retention feature 400 of the rim 360 such that the retention feature 400 interlocks or is at least partially received by the complimentary feature of the hub 310 to prevent the rim 360 from moving relative to the hub 210 after assembly and during use. The retention feature 395 may act to limit or reduce movement of the rim 360 relative to the hub 310. In some examples, the hub 310 may define or include a corresponding hub retaining feature to receive or engage with the rim retention feature 395.

Any of the features, components, and/or parts, including the arrangements and configurations thereof shown in FIG. 9 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 9.

Other examples and implementations are within the scope and spirit of the disclosure and appended claims. For example, features implementing functions may also be physically located at various positions, including being distributed such that portions of functions are implemented at different physical locations. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A closing wheel, comprising:
a hub, including:
an outer circumferential hub surface extending a width between a first hub edge and a second hub edge, the first hub edge defining an outer hub diameter; and
a channel defined by and recessed into the outer circumferential hub surface; and
a rim configured to couple to the hub within the circumferential channel, the rim comprising:
a coupling portion configured to extend into the circumferential channel;
a contact portion extending outward from the coupling portion between a first contact edge and a second contact edge, the contact portion defining:
an outer circumferential wheel surface extending at least the width and between the first contact edge and the second contact edge; and
an outer rim diameter greater than the outer hub diameter.

2. The closing wheel of claim 1, wherein:
the rim defines a central longitudinal axis; and
the rim defines a t-shaped cross sectional area perpendicular to the longitudinal axis.

3. The closing wheel of claim 1, the rim further comprising a retaining feature configured to interface with the hub to resist a movement of the rim relative to the hub.

4. The closing wheel of claim 3, wherein the contact portion defines an inner surface configured to contact the outer circumferential hub surface.

5. The closing wheel of claim 4, wherein the retaining feature extends from the inner surface and engages the outer circumferential hub surface.

6. The closing wheel of claim 5, wherein a hub retaining feature is configured to engage or receive the retaining feature.

7. The closing wheel of claim 1, wherein:
the width is a first width;
the channel includes a second width smaller than the first width; and
the coupling portion includes a third width substantially the same as the second width.

8. A closing wheel coupled to a trailing arm assembly of a planter, the closing wheel comprising:
a hub including an outer hub edge and a width; and
a rim configured to couple to the hub, the rim including:
an outer circumferential rim surface extending at least the width and between a first contact edge and a second contact edge; and
repeating teeth extending radially outward from the outer circumferential rim surface.

9. The closing wheel of claim 8, wherein the outer hub edge defines an outer hub diameter less than an outer rim diameter defined by the outer circumferential rim surface.

10. The closing wheel of claim 8, wherein the dub defines an outer circumferential hub surface defining a channel.

11. The closing wheel of claim 10, wherein the rim includes a coupling portion configured to extend into the channel.

12. The closing wheel of claim 11, wherein the coupling portion includes a coupling width less than the width.

13. The closing wheel of claim 12, wherein the channel includes a channel width substantially the same as the coupling width.

14. The closing wheel of claim 8, wherein the repeating teeth are configured to disturb soil to close a seed furrow.

15. A rim for an agricultural closing wheel, the rim comprising:
a coupling portion having a first width;
a contact portion extending outward from the coupling portion between a first contact edge and a second contact edge, the contact portion defining an outer circumferential surface extending a second width between the first contact edge and the second contact edge, the second width greater than the first width; and
repeating teeth extending radially outward from the outer circumferential surface.

16. The rim of claim 15, wherein the coupling portion and the contact portion define a T-shaped cross-sectional area of the rim.

17. The rim of claim 15, wherein the contact portion is disposed between the coupling portion and the repeating teeth.

18. The rim of claim 15, wherein the contact portion extends perpendicular to the coupling portion.

19. The rim of claim 15, wherein the repeating teeth are configured to disturb soil to close a seed furrow when the rim is coupled to an agricultural trailing arm assembly.

20. The rim of claim 19, further comprising a retaining feature extending from the contact portion opposite the repeating teeth.
